(19) United States
(12) Patent Application Publication
(10) Pub. No.: US 2016/0300309 A1
(43) Pub. Date: Oct. 13, 2016

(54) METHOD FOR INPUTTING HOUSEHOLD ACCOUNTING DATA FOR DOUBLE-ENTRY BOOKKEEPING AND HOUSEHOLD ACCOUNTING SYSTEM USING SAME

(71) Applicant: Yun hwa CHOI, Seoul (KR)

(72) Inventor: Yun hwa CHOI, Seoul (KR)

(21) Appl. No.: 15/038,472

(22) PCT Filed: Dec. 5, 2014
(86) PCT No.: PCT/KR2014/011917

§ 371 Date: May 23, 2016

(30) Foreign Application Priority Data
Dec. 11, 2013 (KR) 10-2013-0154276

(51) Int. Cl. G06Q 40/00; G09B 7/02

(52) U.S. Cl. CPC G06Q 40/12; G09B 7/02

(57) ABSTRACT

Provided is a method for inputting household accounting data for double-entry bookkeeping, the method comprising steps of: a user device 200 which has a household accounting program in a double-entry bookkeeping scheme installed therein and runs the household accounting program, (1) providing a questionnaire for inputting a property overview; (2) receiving a response to the provided questionnaire; (3) automatically inputting property overview data obtained by processing the received response into a financial status of a user in accordance with a double-entry bookkeeping form; and (4) updating the financial status of the user from income or expense data that is received, wherein in (1), an owner item including a person concerned, family members, and a joint ownership is provided together with questions of the questionnaire, and a property owner is allowed to be selected from the owner item.

### TECHNICAL FIELD

Disclosed are a method for inputting household accounting data and a household accounting system using the same, and more particularly, to a method for inputting household accounting data for double-entry bookkeeping and a household accounting system using the same.

### BACKGROUND ART

A household account book may be largely classified into a single-entry bookkeeping household account book and a double-entry bookkeeping household account book. The single-entry bookkeeping household account book simply records a change in income and expense, providing information for identifying a cash flow during a predetermined period of time. The single-entry bookkeeping household account book is easy to use for everyone without a manual, but it only allows to identify simple information about income and expenses, thereby leading to a difficulty in identifying information about a change in the whole property.

The double-entry bookkeeping household account book takes a form of business accounting using debit and credit, and provides information for identifying the current status of assets and liabilities with respect to the whole e property and a net capital, as well as a cash flow of the income and expenses. However, using the double-entry bookkeeping is a challenge to a person who does not have a fundamental knowledge of accounting that is composed of the debit and the credit, and when a user inputs property into the double-entry bookkeeping household account book for the first time, there is difficulty in inputting the property to be divided into asset, liability and capital, leading to the initial use being difficult.

As described above, the double-entry bookkeeping household account book has a benefit in identifying a change of the property and a cash flow, but is not widely used due to the difficulty of use. Accordingly, there is a need to develop a method enabling a user to easily classify and enter a list of property items in accordance with a format without professional accounting knowledge even when using the double-entry bookkeeping household account book for the first time.

Meanwhile, as a method of inputting data into a household account book, a data input method in an electronic household account book or an asset management system, capable of enabling an economic subject to directly input a balance history of financial transaction into the electronic household account book or the asset management system is disclosed (Korean Unexamined Patent Application Publication No. 10-2003-0011386). As such, there has been development on a method of easily inputting deposit and withdrawal data. However, such a conventional method is not suitable for a user to input a list of property items into a double-entry bookkeeping household account book for the first time, thus leaving difficulty using a double-entry bookkeeping. A solution to such a constraint has not been developed yet.

### DISCLOSURE

### Technical Problem

The present invention is suggested to solve the above-mentioned constraints of the existing technologies, and provides a method of inputting household accounting data for double-entry bookkeeping in which a user device having a household accounting program in a double-entry bookkeeping scheme installed therein and running the household accounting program provides a questionnaire for inputting a property overview, and automatically inputs property overview data obtained by processing a received response with respect to the provided questionnaire into a financial status of a user, so that the user may easily input the property overview in accordance with an asset, a capital, and a liability by a process of answering the questionnaire without a knowledge of the double-entry bookkeeping, and a household account book fully implementing a principle of double-entry bookkeeping is created and used, and a household accounting system using the same.

The present invention also provides a method of inputting household accounting data for double-entry bookkeeping in which an owner item for selecting an owner is provided in questions of a questionnaire, so that a financial status is automatically input for each family member of a user who is previously registered, a property status is checked for each family member, and a financial portfolio for the family is constructed, and a household accounting system using the same.

### Technical Solution

According to an aspect of the present invention, there is provided a method for inputting household accounting data for double-entry bookkeeping, the method including steps of: a user device which has a household accounting program in a double-entry bookkeeping scheme installed therein and runs the household accounting program, (1) providing a questionnaire for inputting a property overview; (2) receiving a response to the provided questionnaire; (3) automatically inputting property overview data obtained by processing the received response into a financial status of a user in accordance with a double-entry bookkeeping form; and (4) updating the financial status of the user from income or expense data that is received.

In (1), preferably, the questionnaire may be provided in a multiple-choice type, a short answer type, a narrative type, or an input type so as to enable the input of a property overview without a knowledge of the double-entry bookkeeping.

In (1), preferably, an owner item including a person concerned, family members, and a joint ownership may be provided together with questions of the questionnaire, and a property owner may be allowed to be selected from the owner item.

In (3), more preferably, the response including a selection of the owner may be processed, and may be automatically input into a financial status of each family member in accordance with family members of the user that are previous registered.

In (3), preferably, the received response may be processed such that the property overview data, divided into an asset, a capital, and a liability, may be extracted.

Preferably, a household account book provided by the household accounting program may include a balance sheet and an income/expense change statement; in (3), property overview data of the user may be automatically input into the balance sheet; and in (4), the income or expense data may be input into the income/expense change statement, and the balance sheet may be updated.

According to another aspect of the present invention, there is provided a household accounting system using a method for inputting household accounting data for double-entry bookkeeping, the household accounting system including: a service server configured to provide a household accounting program in a double-entry bookkeeping scheme, and provide an update of the household accounting program; and a user device configured to provide a questionnaire for inputting a property overview by having the household accounting program installed therein and running the household accounting program, automatically input property overview data that is obtained by processing a received response to the provided questionnaire into a financial status of a user in accordance with a double-entry bookkeeping form, and update the financial status of the user from income or expense data that is received.

The financial status of the user may be stored in the service server or the user device depending on a selection of the user.

### Advantageous Effects

According to the method of inputting household accounting data for double-entry bookkeeping of the above-described aspects of the present invention and a household accounting system using the same, a user device which has a household accounting program in a double-entry bookkeeping scheme installed therein and runs the household accounting program provides a questionnaire for inputting a property overview, and automatically inputs property overview data obtained by processing a received response with respect to the provided questionnaire into a financial status of a user, so that the user can easily input the property overview in accordance with an asset, a capital, and a liability by a process of answering the questionnaire without a knowledge of the double-entry bookkeeping, and a household account book fully implementing a principle of double-entry bookkeeping can be created and used.

Also according to the present invention, an owner item for selecting an owner is provided in questions of a questionnaire, so that a financial status can be automatically input for each family member of a user who is previously registered, a property status can be checked for each family member, and a financial portfolio for the family can be constructed.

### DESCRIPTION OF DRAWINGS

FIG. 1 is a view illustrating a household accounting system for implementing a method of inputting household accounting data for double-entry bookkeeping according to an embodiment of the present invention.

FIG. 2 is a flowchart showing a method of inputting household accounting data for double-entry bookkeeping according to an embodiment of the present invention.

FIG. 3 is a view illustrating a user device logging in to a household accounting program, in a method of inputting household accounting data for double-entry bookkeeping according to an embodiment of the present invention.

FIG. 4 is a view illustrating a user device signing up for membership, in a method of inputting household accounting data for double-entry bookkeeping according to an embodiment of the present invention.

FIG. 5 is a view illustrating a user device in which a questionnaire for inputting a property overview is output, in a method of inputting household accounting data for double-entry bookkeeping according to an embodiment of the present invention.

FIG. 6 is a view illustrating a user device in which a household account book having a property overview input therein is output, in a method of inputting household accounting data for double-entry bookkeeping according to an embodiment of the present invention.

FIG. 7 is a view illustrating a user device in which a statistic graph is output, in a method of inputting household accounting data for double-entry bookkeeping according to an embodiment of the present invention.

### MODE FOR INVENTION

Hereinafter, illustrative embodiments and examples of the present disclosure will be described in detail with reference to the accompanying drawings so that the present disclosure may be readily implemented by those skilled in the art. However, it is to be noted that the present disclosure may not be limited to the illustrative embodiments and examples but can be embodied in various other ways. When it is determined that detailed description of known functions or configurations associated with the present disclosure would unnecessarily obscure the gist of the present disclosure, the detailed description thereof will be omitted. Also, like reference numerals denote like parts throughout the whole drawings.

Throughout the whole document, the term “connected to” or “coupled to” that is used to designate a connection or coupling of one element to another element includes both a case that an element is “directly connected or coupled to” another element and a case that an element is “indirectly connected or coupled to” another element while interposing still another element. Throughout the whole document, the term “comprises or includes” and/or “comprising or including” used in the document means that one or more existence or addition of other components, steps, operations and/or elements are not excluded in addition to the described components, steps, operation and/or elements unless context dictates otherwise.

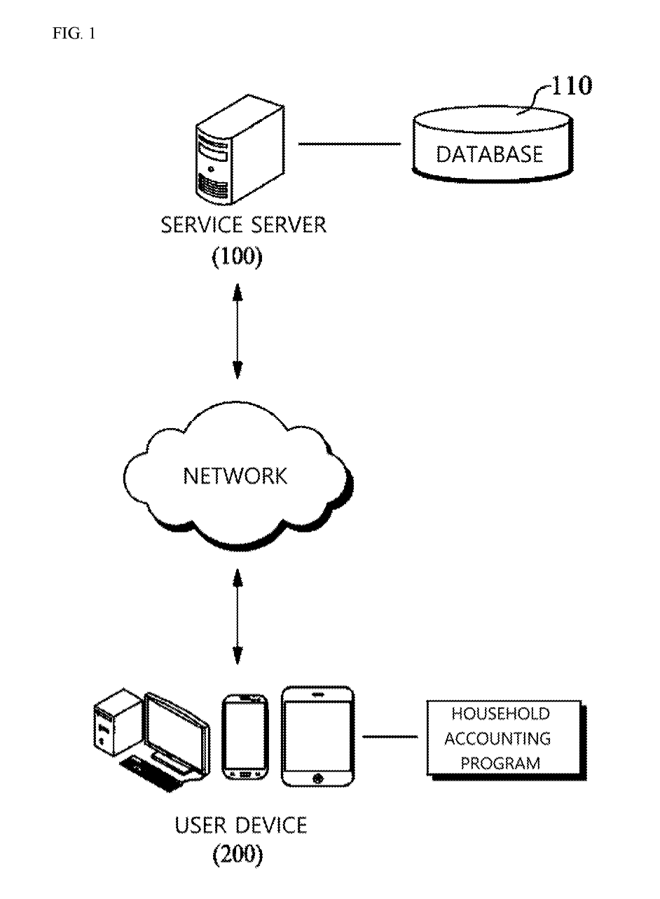

FIG. 1 is a view illustrating a household accounting system for implementing a method of inputting household accounting data for double-entry bookkeeping according to an embodiment of the present invention. As shown in FIG. 1, the household accounting system for implementing the method of inputting household accounting data for double-entry bookkeeping according to an embodiment of the present invention includes a service server 100 and a user device 200.

According to the present invention, the user device 200 which has a household accounting program in a double-entry bookkeeping scheme installed therein and runs the household accounting program may provide a questionnaire for inputting a property overview, and automatically input property overview data that is obtained by processing a received response with respect to the provided questionnaire into a financial status of a user. Accordingly, the property overview may be easily input in accordance with an asset, an capital and a liability by a process of answering the questionnaire, and a household accounting program fully implementing the principle of double-entry bookkeeping may be created and used.

In addition, according to the present invention, an owner item is provided in questions of a questionnaire so that a property owner is allowed to be selected and the selected property owner is automatically input into a financial status for each family member previously registered. Accordingly, a property status may be checked for each family member, and a financial status of the family may be easily planned.

Hereinafter, each part forming the household accounting system for implementing a method of inputting household accounting data for double-entry bookkeeping according to an embodiment of the present invention will be described in detail.

The service server 100 may provide a household accounting program in a double-entry bookkeeping scheme, and provide an update of the household accounting program. In addition, the service server 100 may allow an access of the user device 200 thereto via a network including the Internet, an intranet, a wireless/wired communication network, a mobile communication network, etc. and may transmit and receive various signals and data. In some embodiments, the service server 100 may receive household accounting data from the user device 200, and store the received household accounting data with a user account of a database 110.

The user device 200 may provide a questionnaire for inputting a property overview by having the household accounting program in a double-entry bookkeeping scheme installed therein and running the household accounting program, automatically input property overview data that is obtained by processing a received response with respect to the provided questionnaire into a financial status of a user in accordance with a double-entry bookkeeping form, and update the financial status of the user from income or expense data that is received.

That is, the user device 200 has the household accounting program installed therein, controls execution and termination of the installed household accounting program, and controls detailed operations according to a user's request, so that the user may easily use a double-entry bookkeeping household account book. In particular, a process of inputting property overview data, which is considered difficult to many users who use the double-entry bookkeeping household account book for the first time, is automatized through answering a questionnaire, so that the user's convenience is maximized.

The household accounting program according to the present invention may provide a household account book fully implementing the principle of double-entry bookkeeping. In other words, the household accounting program allows the sum of debits and the sum of credits to be equal in value when a certain item is input so that an equation “Assets=Liabilities+Capital” is always accomplished. As making the sum of the debits and the sum of the credits to be equal in value, a change in property may be systematically identified, and an omitted item may be easily added.

Meanwhile, the household accounting program may provide the double-entry bookkeeping household account book that includes a balance sheet and an income/expense change statement. The balance sheet is a configuration to identify property of an individual person or the family, and the income/expense change statement is a configuration to identify a change in incomes and expenses. The balance sheet includes items of an asset, a liability, and a capital, and an initial financial status is automatically input to be divided into an asset, a liability and a capital through an answer to a questionnaire. The asset may be divided into cash equivalents, investments, tangible assets, and other non-current assets, the liability may be divided into short-term borrowings, long-term borrowings, accrued expenses, accrued payables, and other non-current liabilities, and the capital may be divided into equity capital, family capital, equity capital surplus/deficit, and family capital surplus/deficit. The income/expense change statement may be divided into an income including a fixed-income, such as a salary, and an investment return, an expense including a fixed expense and a consumption expenditure, a cash flow, cash reserves of previous month/previous quarter, and cash reserves of current month/current quarter. In the income/expense change statement, items of monthly incomes and expenses may be recorded, so that a change of cash may be identified. In addition, the asset in the balance sheet may be reflected on the cash reserve of previous month/previous quarter of the income/expense change statement, and the cash flow and the cash reserves of previous month/previous quarter of the income/expense change statement may be reflected on the capital of the balance sheet, and the cash reserves of current month/current quarter may be reflected on the asset of the balance sheet. As such, the balance sheet and the income/expense change statement are interworking with each other, so that a change of property of a user may be continuously identified.

Meanwhile, the household accounting program may be provided directly from the service server 100 to the user device 200 through the network, but may be provided as an execution program that is installed by an installation program managed by an application program server that is operated in a communication network.

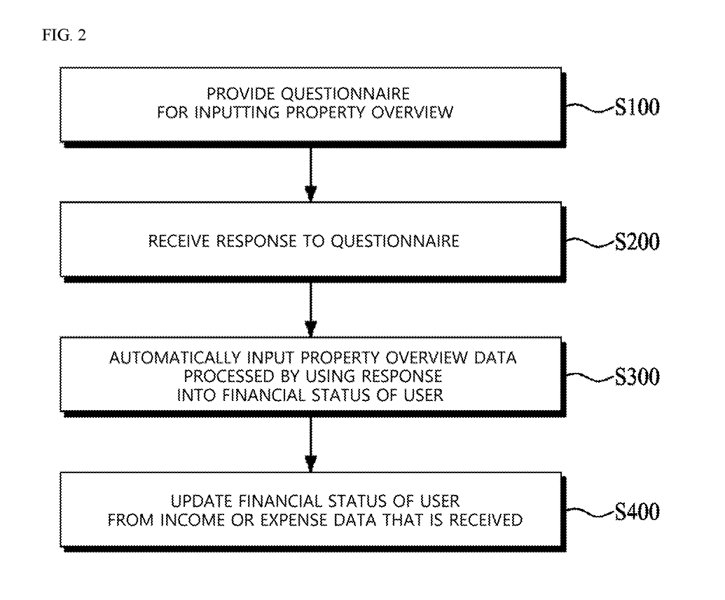

FIG. 2 is a flowchart showing a method of inputting household accounting data for double-entry bookkeeping according to an embodiment of the present invention. As shown in FIG. 2, the method of inputting household accounting data for double-entry bookkeeping according to an embodiment of the present invention may include providing a questionnaire for inputting a property overview (S100), receiving a response to the questionnaire (S200), automatically inputting property overview data obtained by processing the received response into a financial status of a user (S300), and updating the financial status of the user from income or expense data that is received (S400).

In operation S100, the user device 200 may provide a questionnaire for inputting a property overview. That is, as the user device 200 has a double-entry bookkeeping household accounting program installed therein and signs up for membership, a questionnaire is provided to a user such that the user answers the questionnaire. In order to use the double-entry bookkeeping household account book, a process of inputting an asset, a capital, and a liability is needed. In operation S100, for a user who does not have a knowledge of an accounting, the questionnaire for inputting a property overview is provided, so that the user may easily input a property overview divided into an asset, a capital, and a liability by answering the questionnaire.

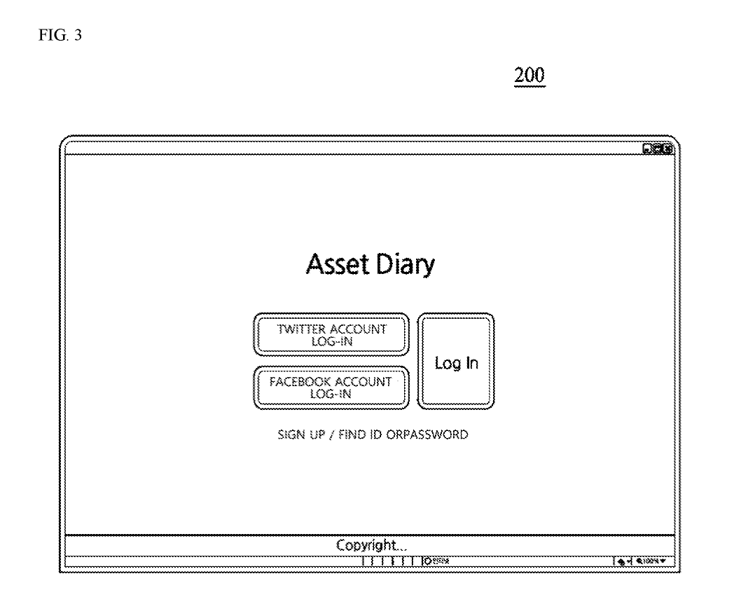

FIG. 3 is a view illustrating the user device 200 logging in to the household accounting program, in the method of inputting household accounting data for double-entry bookkeeping according to an embodiment of the present invention. As shown in FIG. 3, in the method of inputting household accounting data for double-entry bookkeeping according to an embodiment of the present invention, the household accounting program is installed in the user device 200 and executed, and then logged in or signed up for membership. According to the present invention, a log-in or sign-up may be performed by using a Social Network Service (SNS) account, so that creation of an account may be easily achieved and various types of supplementary services may be provided in connection with SNS.

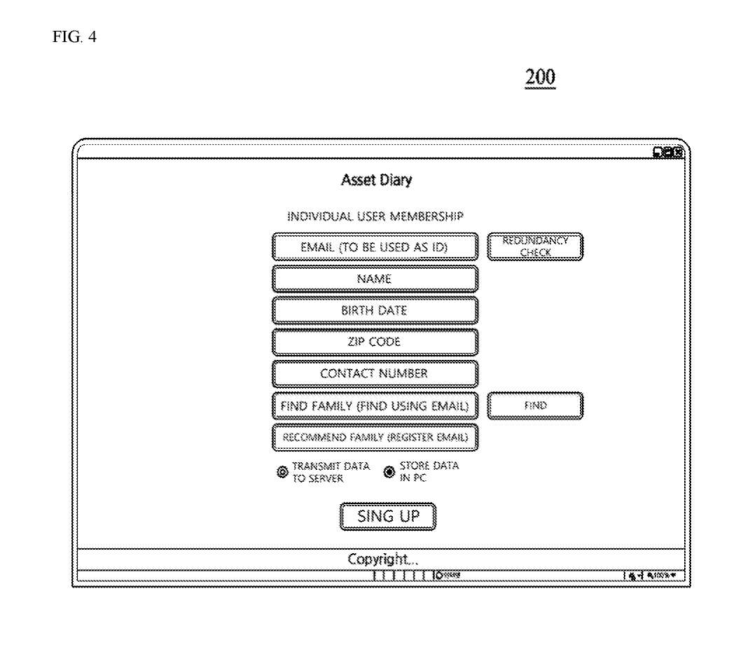

FIG. 4 is a view illustrating the user device 200 signing up for membership, in the method of inputting household accounting data for double-entry bookkeeping according to an embodiment of the present invention. As shown in FIG. 4, in the method of inputting household accounting data for double-entry bookkeeping according to an embodiment of the present invention, membership information including a name and contact information of a user may be input, and the user may become a member. The service server 100 may store the membership information in the database 110 and enroll the user as a member, and charge a predetermined service fee or provide an update patch at the time of a update of the household accounting program. In addition, the service server 100 prohibits a log-in to the household accounting program unless preset membership information is used, thereby preventing a financial status of the user from leaking to the outside.

Meanwhile, the user device 200 may store the financial status of the user in the service server 100 or the user device 200 according to a user's selection. That is, when a user selects “transmit data to server” on a screen shown in FIG. 4, household accounting data is transmitted to the service server 100 and is stored in the database 110, so that a financial status of the user is stored in the service server 100. Alternatively, when a user selects “store data in PC”, household accounting data is stored in the user device 200, and the user device 200 may prevent the service server 100 from obtaining a financial status of the user without permission. The user device 200 may be provided as a smart device or a mobile device as well as a personal computer, and various user devices may serve as the user device 200 regardless of the form as long as it can install a household accounting program therein and automatically input property overview data into a financial status through a questionnaire.

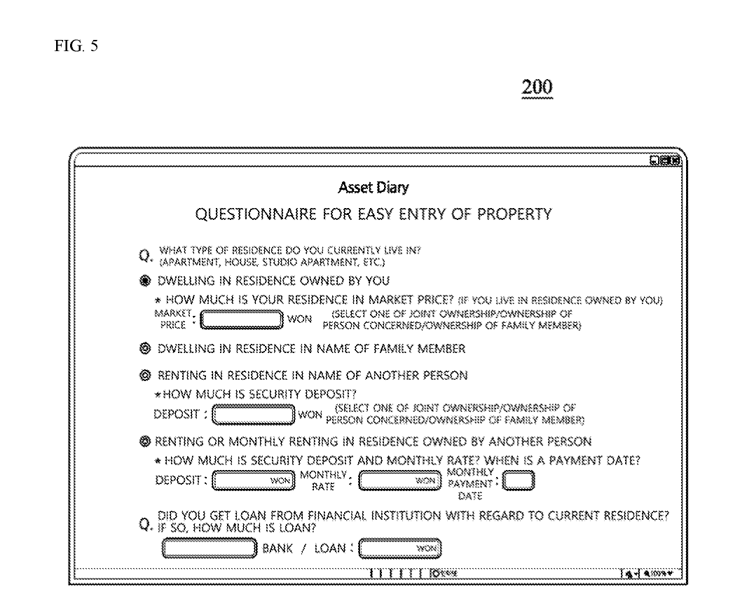

FIG. 5 is a view illustrating the user device 200 in which a questionnaire for inputting a property overview is output, in the method of inputting household accounting data for double-entry bookkeeping according to an embodiment of the present invention. As shown in FIG. 5, in operation S100 of the method of inputting household accounting data for double-entry bookkeeping according to an embodiment of the present invention, the user device 200 may provide a questionnaire for inputting a property overview. In operation S100, the questionnaire may be provided in a multiple-choice type, a short answer type, a narrative type, or an input type so as to enable the input of a property overview without a knowledge of the double-entry bookkeeping. As shown in FIG. 5, the questionnaire may be provided as a combination of a multiple-choice type, a short answer type, a narrative type, and an input type.

In operation S100, an owner item including a person concerned, family members, and a joint ownership is provided together with questions of the questionnaire so that a property owner is allowed to be selected from the owner item. That is, since a nominee of each property is allowed to be selected at the same time when a property overview is input, the property status of the family may be precisely identified, and properties in the names of respective family members may be managed for each family member. For example, as shown in FIG. 5, a user may select an owner while inputting a residence.

In operation S200, the user device 200 may receive a response to the provided questionnaire. That is, as shown in FIG. 5, a response may be input by marking an option corresponding to each question, and entering a market price and deposit money in the form of a number or a text. In addition, the user device 200 may enable a response to be easily input by providing a search function regarding a bank name.

In operation S300, the user device 200 may automatically input property overview data obtained by processing the received response into a financial status of a user in accordance with a double-entry bookkeeping form. That is, in operation S300, the user device 200 processes the received response, and extracts property overview data divided into an asset, a capital, and a liability. According to operation S300, a user may generate a double-entry bookkeeping household account book in which property overview data, needed to use the double-entry bookkeeping household account book, is precisely divided and entered, without having to understand a precise concept of an asset, a capital, and a liability, or having a knowledge of accounting.

The household account book provided by the household accounting program may include a balance sheet and an income/expense change statement, and represent a financial status of a user through the balance sheet and the income/expense change statement. In some embodiments, the household account book may further include a property overview. In operation S300, property overview data of a user may be automatically input into the balance sheet, and also into the property overview. Particularly, in operation S300, the property overview data is automatically input into the balance sheet and the property overview while automatically divided into an asset, a liability, a capital, and so on.

Meanwhile, in operation S300, the response including a selection of the owner may be processed and automatically input into a financial status of a family member in accordance with family members of the user that are previous registered. That is, as shown in FIG. 5, a questionnaire for inputting a property owner is provided in operation S100, a response including a selection of the property owner is received in operation S200, and property overview data is input into a balance sheet and a property overview on the basis of a selected family member in operation 300. In addition, a balance sheet and a property overview for the family may be generated.

In operation S300, as the property overview data is automatically input into the balance sheet, and so on, a double-entry bookkeeping household account book may be generated. The generated double-entry bookkeeping household account book may represent the present state of a financial status of a user. When the user logs in to the user device 200 at a later time again, the user device 200 may immediately provide the previously generated double-entry bookkeeping household account book without operations S100 to S300.

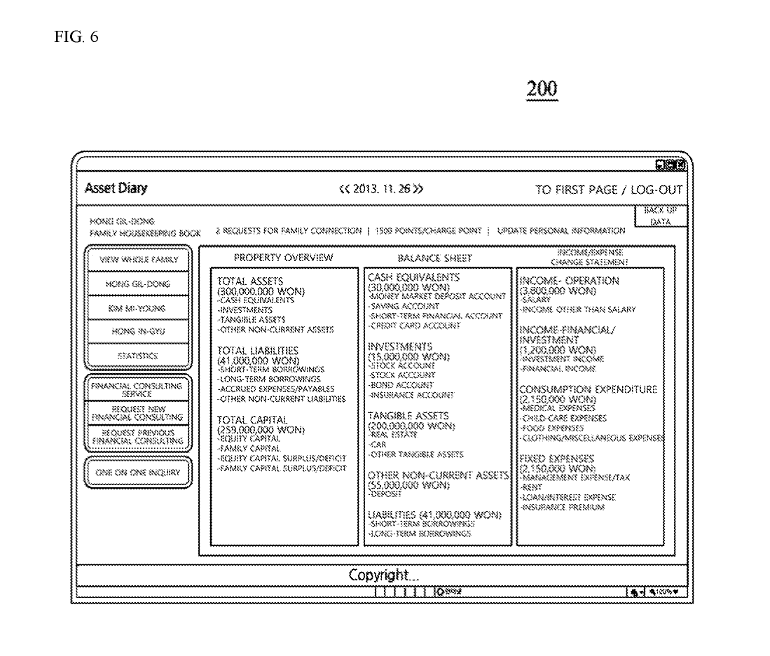

FIG. 6 is a view illustrating the user device 200 in which a household account book having a property overview input therein is output, in the method of inputting household accounting data for double-entry bookkeeping according to an embodiment of the present invention. As shown in FIG. 6, in operation S300 of the method of inputting household accounting data for double-entry bookkeeping according to an embodiment of the present invention, property overview data obtained by processing the response received in operation S200 is input to be divided in accordance with a double-entry bookkeeping form, so that a double-entry bookkeeping household account book of the user may be generated. The user device 200 may automatically input the property overview and each item of the balance sheet by processing the response to the questionnaire. A user may select an item shown in FIG. 6 to check details of each item. In addition, a user may select a family member in a left side menu to check a financial status of each family member.

Meanwhile, since the household account book generated in operation S300 of the present application fully implements the principle of double-entry bookkeeping, an equation “Assets=Liabilities+Capital” is always accomplished. For example, in the property overview shown in FIG. 6, an equation “Assets (300,000,000 won)=Liabilities (41,000,000 won)+Capital (259,000,000 won)” is always accomplished.

In operation S400, the user device 200 may update the financial status of the user from income or expense data that is received. That is, operation S400 may be a process of keeping a record of household account book by inputting the income or expense data into the double-entry bookkeeping household account book generated in operation S300.

In operation S400, the income or expense data may be input into the income/expense change statement, and the balance sheet may be updated. As shown in FIG. 6, the income or expense data may be checked from the income/expense change statement. Since the balance sheet and the income/expense change statement are interworking with each other to continuously represent a change of the property, the balance sheet and the income/expense change statement may be updated by using the income or expense data in operation S400.

The user device 200 may statistically process a change of a financial status of a user during a predetermined period of time, and provide a result of the processing in the form of a graph. That is, from the property overview shown in FIG. 6, it is not easy to intuitively understand a change in the financial status. Accordingly, the user device 200 according to the present invention may provide a graph obtained by statistically processing each item representing a financial status, thereby improving the user's satisfaction.

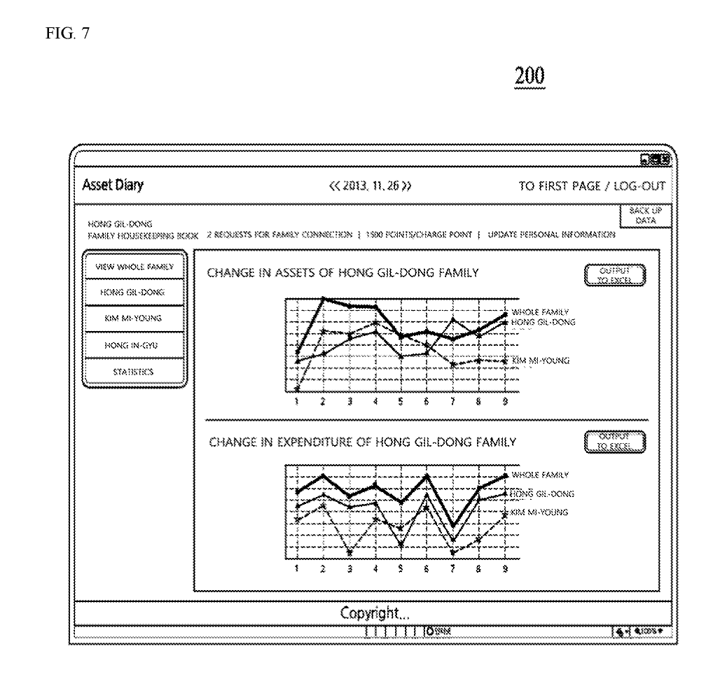

FIG. 7 is a view illustrating the user device 200 in which a statistic graph is output, in the method of inputting household accounting data for double-entry bookkeeping according to an embodiment of the present invention. As show in FIG. 7, in the method of inputting household accounting data for double-entry bookkeeping according to an embodiment of the present invention, a result statistically processed in accordance with items of assets and expenses or in accordance with family members may be output as a graph. Through the graph, a user may intuitively understand a change in the property status of assets, expenses, and incomes, and construct a future portfolio.

Although a few embodiments have been described, it will be understood by those of ordinary skill in the art that various changes in form and details may be made therein without departing from the spirit and scope of the present invention as defined by the following claims.

### DESCRIPTION OF REFERENCE NUMERALS

100: SERVICE SERVER
110: DATABASE
200: USER DEVICE
S100: PROVIDE QUESTIONNAIRE FOR INPUTTING PROPERTY OVERVIEW
S200: RECEIVE RESPONSE TO QUESTIONNAIRE
S300: AUTOMATICALLY INPUT PROPERTY OVERVIEW DATA PROCESSED BY USING RESPONSE INTO FINANCIAL STATUS OF USER
S400: UPDATE FINANCIAL STATUS OF USER FROM INCOME OR EXPENSE DATA THAT IS RECEIVED

1. A method for inputting household accounting data for double-entry bookkeeping, the method comprising steps of: a user device 200 which has a household accounting program in a double-entry bookkeeping scheme installed therein and runs the household accounting program,
(1) providing a questionnaire for inputting a property overview;
(2) receiving a response to the provided questionnaire;
(3) automatically inputting property overview data obtained by processing the received response into a financial status of a user in accordance with a double-entry bookkeeping form; and
(4) updating the financial status of the user from income or expense data that is received,
wherein in (1), an owner item including a person concerned, family members, and a joint ownership is provided together with questions of the questionnaire, and a property owner is allowed to be selected from the owner item.

2. The method of claim 1, wherein in (1), the questionnaire is provided in a multiple-choice type, a short answer type, a narrative type, or an input type so as to enable the input of a property overview without a knowledge of the double-entry bookkeeping.

3. The method of claim 1, wherein in (3), the response including a selection of the owner is processed, and is automatically input into a financial status of each family member in accordance with family members of the user that are previous registered.

4. The method of claim 1, wherein in (3), the received response is processed such that the property overview data, divided into an asset, a capital, and a liability, is extracted.

5. The method of claim 1, wherein:
a household account book provided by the household accounting program includes a balance sheet and an income/expense change statement;
in (3), property overview data of the user is automatically input into the balance sheet; and
in (4), the income or expense data is input into the income/expense change statement, and the balance sheet is updated.

6. A household accounting system using a method for inputting household accounting data for double-entry bookkeeping, the household accounting system comprising:
a service server 100 configured to provide a household accounting program in a double-entry bookkeeping scheme, and provide an update of the household accounting program; and
a user device 200 configured to provide a questionnaire for inputting a property overview by having the household accounting program installed therein and running the household accounting program, automatically input property overview data that is obtained by processing a received response to the provided questionnaire into a financial status of a user in accordance with a double-entry bookkeeping form, and update the financial status of the user from income or expense data that is received,
wherein the user device 200 provides an owner item including a person concerned, family members, and a joint ownership together with questions of the questionnaire, and allows a property owner to be selected from the owner item.

7. The household accounting system of claim 6, wherein the financial status of the user is stored in the service server 100 or the user device 200 depending on a selection of the user.
